(19) United States
(12) Patent Application Publication
(10) Pub. No.: US 2006/0220779 A1
(43) Pub. Date: Oct. 5, 2006

(54) Adjustable safety switch

(76) Inventor: Tsung-Mou Yu, Taipei (TW)

Correspondence Address: LIN & ASSOCIATES INTELLECTUAL PROPERTY, P.O. BOX 2339, SARATOGA, CA, 95070-0339, US

(21) Appl. No.: 11/093,214

(22) Filed: Mar. 29, 2005

(51) Int. Cl. H01H 37/12; H01H 37/54

(52) U.S. Cl. 337/66

(57) ABSTRACT

A switch device includes a body with a switch member pivotably engaged with a top opening of the body and a first terminal and a second terminal respectively extend through two slots in a bottom of the body. A first contact point is connected to the second terminal. A bi-metallic plate has a first end fixed to the first terminal and a second contact point is connected to an underside of a second end of the bimetallic plate. The second contact point is located above the first contact point. A link has an upper end pivotably connected to the switch member and a lower end of the link clamps the second end of the bimetallic plate. A connection member is fixedly connected to an inside of the body and an adjusting member movably extends through a wall of the body and contacts the connection member. A U-shaped biasing member has a first end connected to the second end of the bimetallic plate and a second end of the biasing member is connected to the connection member. The biasing member provides the bimetallic plate proper flexibility so as to ensure the deformation of the bimetallic plate when overload.

### FIELD OF THE INVENTION

The present invention relates to a safety switch including an adjusting assembly connected to the bimetallic plate so as to ensure that the bimetallic plate is deformed as desired when overload.

### BACKGROUND OF THE INVENTION

A conventional switch device, especially for those switches using bimetallic plate to prevent from being burn when an overload is happened, generally includes a bimetallic plate which is deformed when overload so as to separate the two contact points respectively located on the bimetallic plate and one of the two terminals. Some inherent shortcomings for these conventional safety switch devices are found. There are too many parts involved in the safety switch device and a longer period of time is required when assembling the switch device, this increases the cost of the products. The parts might be arranged inaccurately and affects the deformation of the bimetallic plate. Once the bimetallic plate is deformed to cut off the circuit, because of the improper arrangement of the parts as mentioned above, the bimetallic plate could deform to re-connect the two contact points to connect the circuit again. Because the inaccuracy of the deformation of the bimetallic plate, the switch member does not set the “OFF” position after the bimetallic plate is deformed to cut off the circuit.

Therefore, it is desired to have a safety switch wherein the bimetallic plate is ensured to have proper flexibility and deformed to separate the two contact points when overload.

### SUMMARY OF THE INVENTION

In accordance with an aspect of the present invention, there is provided a switch device that comprises a body with a top opening with which a switch member is pivotably engaged, two slots are defined through an underside of the body so that a first terminal and a second terminal respectively extend through the two slots. A first contact point is connected to the second terminal. A bimetallic plate has a first end fixed to the first terminal and a second contact point is connected to an underside of a second end of the bimetallic plate. The second contact point is located above the first contact point. A link has an upper end pivotably connected to the switch member and a lower end of the link clamps the second end of the bimetallic plate. An adjusting assembly includes a connection member fixedly connected to an inside of the body and an adjusting member movably extends through a wall of the body and contacts the connection member. A biasing member has a first end connected to the second end of the bimetallic plate and a second end of the biasing member is connected to the connection member.

The main object of the present invention is to provide a safety switch that uses an adjusting assembly, which adjusts the curvature of the biasing member so that the bimetallic plate is ensured to be deformed toward desired direction to cut the circuit.

Another object of the present invention is to provide a safety switch that includes less number of parts so as to have lower manufacturing cost.

The present invention will become more obvious from the following description when taken in connection with the accompanying drawings, which show, for purposes of illustration only, a preferred embodiment in accordance with the present invention.

### BRIEF DESCRIPTION OF THE DRAWINGS

FIG. 1 is an exploded view of a safety switch device in accordance with the present invention;

FIG. 2 shows the bimetallic plate is in “OFF” position of the safety switch of the present invention, and

FIG. 3 shows the bimetallic plate is in “ON” position of the safety switch of the present invention.

### DETAILED DESCRIPTION OF THE PREFERRED EMBODIMENT

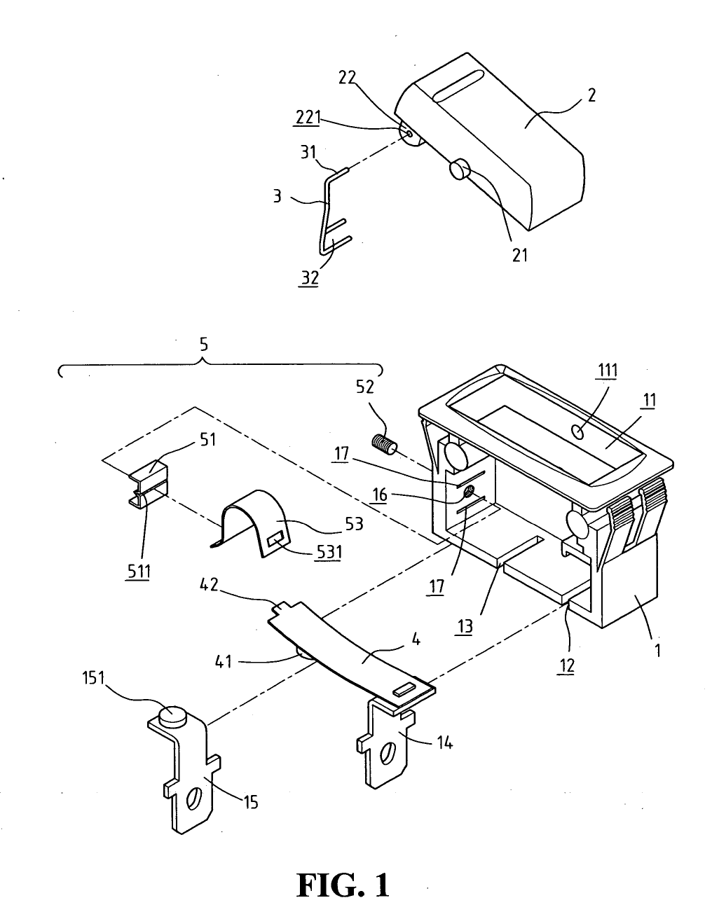

Referring to the drawings and in particular FIGS. 1-3, a safety switch device comprises a body 1 with a top opening 11 and two pivot holes 111 are defined through two opposite walls of the body 1. A switch member 2 is pivotably engaged with the top opening 11 of the body 1 by pivotally engaging two pivots 21 extending from two sides of the switch member 2 with the two pivot holes 111. A protrusion 22 extends from an underside of an end of the switch member 2 and includes a receiving hole 221. Two slots 12, 13 are defined through an underside of the body 1 so that a first terminal 14 and a second terminal 15 respectively extend through the two slots 12, 13. A first contact point 151 is connected to the second terminal 15. A bimetallic plate 4 has a first end fixed to a top of the first terminal 14 and a second contact point 41 connected to an underside of a second end of the bimetallic plate 4. The second contact point 41 is located above the first contact point 151. Two slits 17 are defined in an inside of the body 1 and a through hole 16 is defined through a wall of the body 1 and located between the two slits 17.

A link includes an upper end which is pivotably engaged with the receiving hole 221 in the protrusion 22 of the switch member 2 and a lower end of the link 3 includes two bars between which a space 32 is defined. The second end of the bimetallic plate 4 is clamped in the space 32.

An adjusting assembly 5 includes a connection member 51, a connection member 51, a biasing member 53, and an adjusting member 52. The connection member 51 is an E-shaped member and the upper and lower extensions of the E-shaped connection member 51 are engaged with the slits 17 and the adjusting member 52 such as a bolt movably extends through the through hole 16 and contacts the connection member 51. The biasing member 53 is a U-shaped plate and the first end of the biasing member 53 includes a through hole 531 and the second end of the bimetallic plate 4 includes a tongue 42 which is engaged with the through hole 531. A second end of the biasing member 53 is inserted in the engaging slit 511 of the connection member 51.

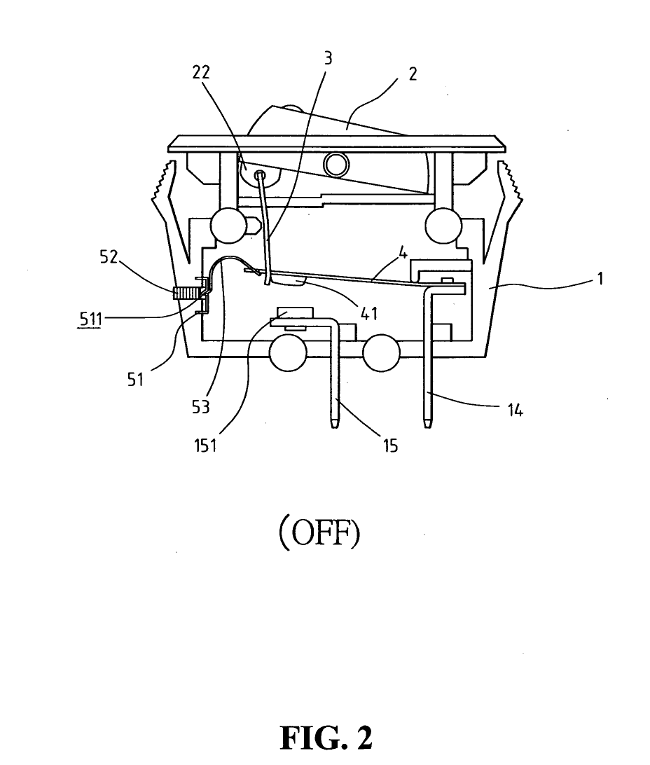

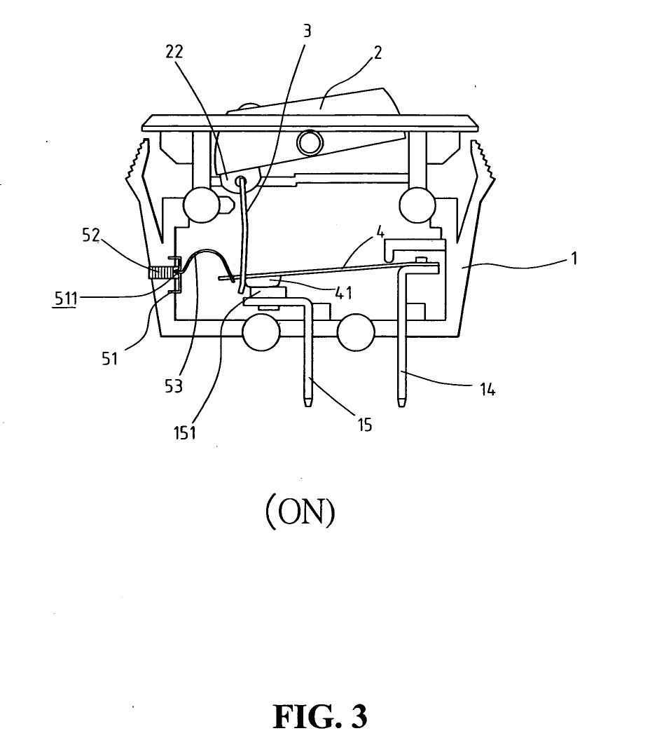

As shown in FIGS. 2 and 3, when the switch device is in “ON” position, the left end of the switch member 2 is pushed and the second end of the bimetallic plate 4 is pushed downward by the lower end of the link 3. The first and second contact points 41, 151 are in contact with each other so that circuit is in “ON” status. When the switch device is in “ON” position and the current is overload, the bimetallic plate 4 is deformed upward and the first and second contact points 41, 151 are separated so that the circuit is cut off. The biasing member 53 ensures that the bimetallic plate 4 has sufficient force to be deformed as desired. The curvature of the biasing member 53 can be adjusted by moving the adjusting member 52 to move the connection member 51 toward the biasing member 53 or to move in a direction away from the biasing member 53. When the right end of the switch member 2 is pushed, the second end of the bimetallic plate 4 is lifted by the lower end of the link 3 and the first and second contact points 41, 151 are separated so that circuit is in “OFF” status.

While we have shown and described the embodiment in accordance with the present invention, it should be clear to those skilled in the art that further embodiments may be made without departing from the scope of the present invention.

What is claimed is:

1. A switch device comprising:
a body with a top opening and two slots defined through an underside of the body, a first terminal and a second terminal extending through the two slots and a first contact point connected to the second terminal;
a bimetallic plate having a first end fixed to the first terminal and a second contact point connected to an underside of a second end of the bimetallic plate, the second contact point located above the first contact point;
a switch member pivotably engaged with the top opening of the body;
a link having an upper end pivotably connected to the switch member and a lower end of the link clamping the second end of the bimetallic plate, and
an adjusting assembly including a connection member fixedly connected to an inside of the body and an adjusting member movably extending through a wall of the body and contacting the connection member, a biasing member having a first end connected to the second end of the bimetallic plate and a second end of the biasing member being connected to the connection member.

2. The device as claimed in claim 1, wherein a protrusion extends from an underside of an end of the switch member and includes a receiving hole, the upper end of the link extends pivotably inserted in the receiving hole.

3. The device as claimed in claim 1, wherein the lower end of the link includes two bars between which a space is defined, the second end of the bimetallic plate is clamped in the space.

4. The device as claimed in claim 1, wherein two pivot holes are defined through two opposite walls of the body and two pivots extend from two sides of the switch member, the two pivots are pivotably engaged with the two pivot holes.

5. The device as claimed in claim 1, wherein a through hole defined through the inside of the body and at least one slit defined in the inside of the body, the connection member is engaged with the at least one slit and the adjusting member movably extends through the through hole.

6. The device as claimed in claim 1, wherein the connection member is a bolt.

7. The device as claimed in claim 1, wherein the connection member has at least one engaging slit and the second end of the biasing member is engaged with the at least one engaging slit.

8. The device as claimed in claim 1, wherein the biasing member is a U-shaped plate.

9. The device as claimed in claim 1, wherein the first end of the biasing member includes a through hole and the second end of the bimetallic plate includes a tongue which is engaged with the through hole.
